(19) United States
(12) Patent Application Publication
(10) Pub. No.: US 2011/0254788 A1
(43) Pub. Date: Oct. 20, 2011

(54) MOVABLE TOUCH MODULE AND ELECTRONIC DEVICE USING THE SAME

(76) Inventors: Li-Bao Wang, Shanghai (CN); Shih-Wei Hung, Taipei City (TW)

(21) Appl. No.: 13/087,790

(22) Filed: Apr. 15, 2011

(30) Foreign Application Priority Data
Apr. 15, 2010 (CN) 201010148234.2

(51) Int. Cl. G06F 3/041

(52) U.S. Cl. 345/173

(57) ABSTRACT

A movable touch module and an electronic device using the same are provided. The movable touch module is disposed at a main body and includes a first movable element, a second movable element, a touch unit, at least four movement sensing elements, and at least two rotation sensing elements. The first movable element is disposed at the main body and is rotatable relative to the main body on a plane. The second movable element is disposed at the first movable element and is capable of moving relative to the first movable element along a first direction. The touch unit is disposed at the second movable element and is capable of moving relative to the second movable element along a second direction. The movement sensing elements and the rotation sensing elements are fastened to the main body.

### CROSS REFERENCE TO RELATED APPLICATIONS

This Non-provisional application claims priority under 35 U.S.C. §119(a) on Patent Application No(s). 201010148234.2 filed in People's Republic of China on Apr. 15, 2010, the entire contents of which are hereby incorporated by reference.

### BACKGROUND OF THE INVENTION

1. Field of Invention

This invention relates to an input device and, more particularly, to a movable touch module and an electronic device using the same.

2. Related Art

With development of science, electronic devices, such as a notebook computer, a mobile communication device, and a media player, have been necessary equipment in people's daily life. In addition, with gradual development of a market, besides functionality of the electronic devices, designs and shapes of the devices are main factors affecting purchase of consumers.

A notebook computer is taken for example. At present, the notebook computer usually has a touchpad to replace a mouse. However, the present touchpad is usually fastened to a main body of the notebook computer, which fails to provide a novel design to show individual styles and also fails to provide intuitive operation such as moving or rotating for users. In addition, when a screen of a notebook computer is not large enough, the users usually need to move a web page upward, downward, leftward, or rightward for complete browse. However, the present touchpad fails to conveniently achieve the above operation.

### SUMMARY OF THE INVENTION

This invention provides a movable touch module and an electronic device using the same to improve the prior art.

This invention provides a movable touch module disposed at a main body. The movable touch module includes a first movable element, a second movable element, a touch unit, at least four movement sensing elements, and at least two rotation sensing elements. The first movable element is disposed at the main body and is rotatable relative to the main body in a plane. The second movable element is disposed at the first movable element and is capable of moving relative to the first movable element along a first direction. The touch unit is disposed at the second movable element and is capable of moving relative to the second movable element along a second direction. The movement sensing elements and the rotation sensing elements are fastened to the main body. When the first movable element rotates on the plane, the first movable element triggers one of the rotation sensing elements. When the second movable element moves along the first direction, the second movable element triggers one of the movement sensing elements. When the touch unit moves along the second direction, the touch unit triggers one of the movement sensing elements.

This invention provides an electronic device including a main body and a movable touch module. The movable touch module is disposed at the main body and includes a first movable element, a second movable element, a touch unit, at least four movement sensing elements, and at least two rotation sensing elements. The first movable element is disposed at the main body and is rotatable relative to the main body on a plane. The second movable element is disposed at the first movable element and is capable of moving relative to the first movable element along a first direction. The touch unit is disposed at the second movable element and is capable of moving relative to the second movable element along a second direction. The movement sensing elements and the rotation sensing elements are fastened to the main body. When the first movable element rotates on the plane, the first movable element triggers one of the rotation sensing elements. When the second movable element moves along the first direction, the second movable element triggers one of the movement sensing elements. When the touch unit moves along the second direction, the touch unit triggers one of the movement sensing elements.

In the invention, the first movable element of the movable touch module is rotatable relative to the main body on a plane; the second movable element is capable of moving relative to the first movable element along a first direction; the touch unit is capable of moving relative to the second movable element along a second direction. Thereby, a user can operate the touch unit to move along the second direction or to drive the second movable element to move along the first direction to trigger different movement sensing elements. In addition, the user can further operate the touch unit to drive the first movable element to rotate on the plane to trigger different rotation sensing elements, thereby achieving different functions. Thus, the movable touch module and the electronic device using the same in the invention provide a novel design and a convenient and efficient operating mode.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing an electronic device according to one preferred embodiment of the invention;

FIG. 2 is a partial top view showing an electronic device according to one preferred embodiment of the invention;

FIG. 3 is a partial exploded diagram showing an electronic device according to one preferred embodiment of the invention;

FIG. 4A and FIG. 4B are partial assembling diagrams showing a movable touch module according to one preferred embodiment of the invention; and

FIG. 5 is a schematic diagram showing rotation of a movable touch module according to one preferred embodiment of the invention.

### DETAILED DESCRIPTION OF THE INVENTION

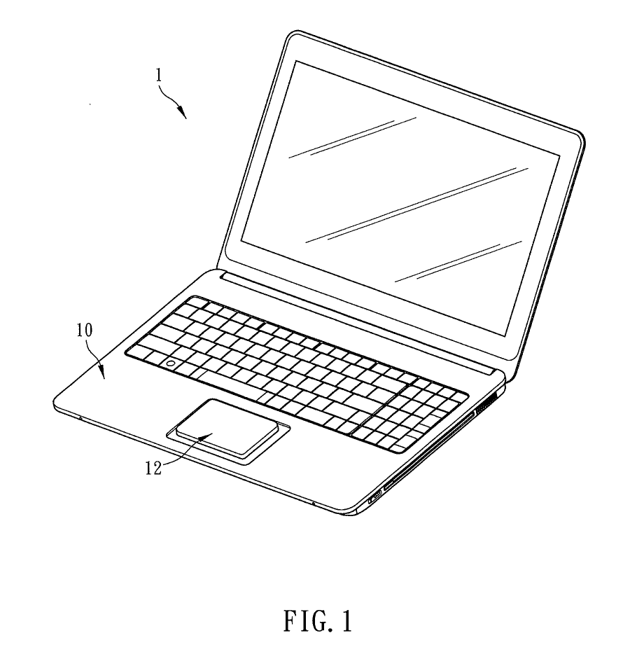

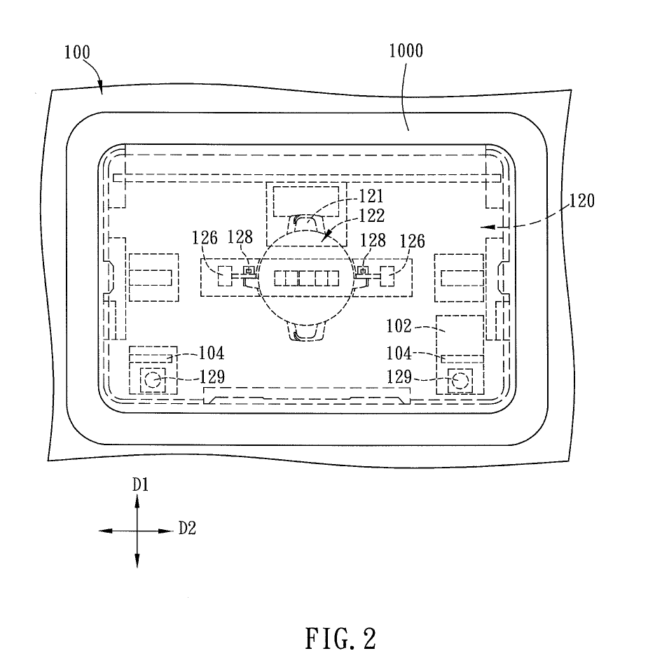

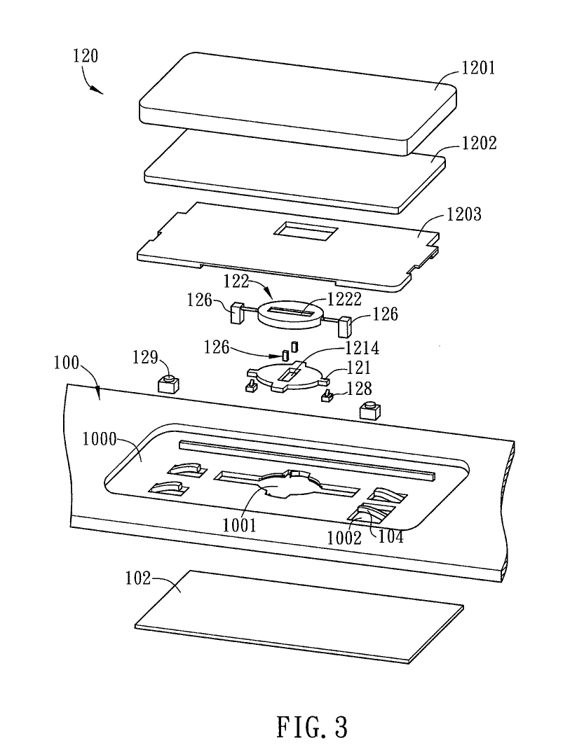

FIG. 1 is a schematic diagram showing an electronic device according to one preferred embodiment of this invention. FIG. 2 is a partial top view showing an electronic device according to one preferred embodiment of the invention. FIG. 3 is a partial exploded diagram showing an electronic device according to one preferred embodiment of the invention. Please refer to FIG. 1, FIG. 2, and FIG. 3. In the embodiment, an electronic device 1 includes a main body 10 and a movable touch module 12.

In the embodiment, the electronic device 1 is a notebook computer. However, the invention is not limited thereto. In other embodiments, the electronic device 1 may be other electronic devices such as a mobile communication device or a media player.

In the embodiment, the movable touch module 12 is disposed at the main body 10. The main body 10 includes a casing 100, a circuit board 102, and a plurality of elastic elements 104. The circuit board 102 and the elastic elements 104 are disposed at the casing 100. The movable touch module 12 includes a first movable element 121, a second movable element 122, a touch unit 120, four movement sensing elements 126, two rotation sensing elements 128, and two pressing switches 129.

In the embodiment, the first movable element 121 is disposed at the main body 10 and is rotatable relative to the main body 10 on a plane. In the embodiment, the plane is a plane where the circuit board 102 is disposed. However, the invention is not limited thereto. In a practical application, the plane where the first movable element 121 is rotatable relative to the main body 10 may be set according to needs.

In the embodiment, the second movable element 122 is disposed at the first movable element 121 and is capable of moving relative to the first movable element 121 along a first direction D1. The touch unit 120 is disposed at the second movable element 122 and is capable of moving relative to the second movable element 122 along a second direction D2. In the embodiment, the first direction D1 and the second direction D2 are parallel to the plane where the first movable element 121 is rotatable relative to the main body 10 (in the embodiment, it is the plane where the circuit board 102 is disposed), and the first direction D1 is vertical to the second direction D2. However, the invention is not limited thereto. In a practical application, the first direction D1 and the second direction D2 may be set to have other angles (such as 60 degrees) according to needs.

In addition, in the embodiment, the movement sensing elements 126, the rotation sensing elements 128, and the pressing switches 129 may be fastened to the circuit board 102 via surface mount technology (SMT). The two movement sensing elements 126 are disposed along the first direction D1, and the other two movement sensing elements 126 are disposed along the second direction D2.

In the embodiment, an assembling direction of the touch unit 120, the second movable element 122, the first movable element 121, and the circuit board 102 is vertical to the plane where the first movable element 121 is rotatable relative to the main body 10 (in the embodiment, it is the plane where the circuit board 102 is disposed). In detail, the touch unit 120, the second movable element 122, and the first movable element 121 are stacked on the circuit board 102. The circuit board 102 may be fastened to the bottom (not shown) of the casing 100 via screws.

In the embodiment, the casing 100 of the main body 10 is a casing of a notebook computer. The first movable element 121, the second movable element 122, and the touch unit 120 are stacked in the casing 100. In detail, in FIG. 3, the casing 100 has a recessed containing area 1000 for containing the first movable element 121, the second movable element 122, and the touch unit 120. The containing area 1000 has a first opening 1001 and a plurality of second openings 1002. However, the invention is not limited thereto. In other embodiments, the containing area 1000 may only have one opening.

In the embodiment, the first movable element 121 is disposed at the first opening 1001, and the first movable element 121 can rotate on the plane where the circuit board 102 is disposed via the first opening 1001. The shape of the first opening 1001 conforms to that of the first movable element 121, and the first opening 1001 is greater than the first movable element 121, thereby preventing movement of the touch unit 120 and the second movable element 122 from affecting the first movable element 121. In addition, the elastic elements 104 are disposed at the second openings 1002, respectively. The two pressing switches 129 fastened to the circuit board 102 are protrudent from the second openings 1002, respectively, and are located below the elastic elements 104. In the embodiment, the main body 10 has four elastic elements 104, and the elastic elements 104 are elastic sheets integrally formed with the casing 100. However, the invention does not limit the number (such as two) and type (such as springs) of the elastic elements 104.

In the embodiment, the touch unit 120 covers the two pressing switches 129. Thereby, a user can press a corresponding place of the touch unit 120 to trigger the corresponding pressing switch 129. In addition, when the user releases the touch unit 120, the elastic elements 104 disposed at the casing 100 can push the touch unit 120 back to an initial position. The invention does not limit the positions of the pressing switches 129. In FIG. 2, the two pressing switches 129 may correspond to left and right sides of the touch unit 120. The two pressing switches 129 are equivalent to left and right buttons around a touch area of a conventional notebook computer. In other words, the movable touch module 12 in the embodiment has a left and right button function.

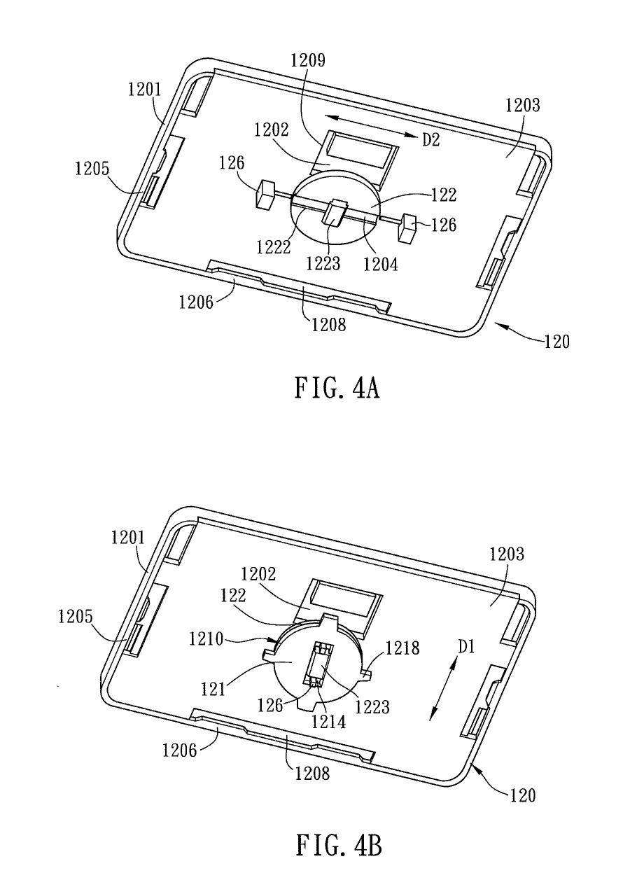

FIG. 4A and FIG. 4B are partial assembling diagrams showing the movable touch module 12 according to one preferred embodiment of the invention. Please refer to FIG. 2, FIG. 3, FIG. 4A, and FIG. 4B. To clearly show the structure of the movable touch module 12, FIG. 4A and FIG. 4B are bottom views of the movable touch module 12 in FIG. 2. In addition, in FIG. 4A, only the touch unit 120, the second movable element 122, and the two movement sensing elements 126 disposed along the second direction D2 are shown. In FIG. 4B, only the touch unit 120, the second movable element 122, the first movable element 121, and the two movement sensing elements 126 disposed along the first direction D1 are shown.

In the embodiment, the touch unit 120 is rectangular. However, the invention is not limited thereto. In a practical application, the touch unit with different shapes (such as a circle or an ellipse) may be set according to needs.

In the embodiment, the touch unit 120 includes a touch pad casing 1201, a touch pad 1202, and a touch pad cover 1203. The touch pad 1202 and the touch pad cover 1203 are stacked in the touch pad casing 1201, and the touch pad cover 1203 is disposed at the second movable element 122. In detail, in FIG. 4A and FIG. 4B, the touch pad casing 1201 has three protrudent side walls 1205, and the side walls have a plurality of stopping blocks 1206. The touch pad 1202 and the touch pad cover 1203 can be assembled into the touch pad casing 1201 via one side of the touch pad casing 1201 without the protrudent side wall in order. In addition, the stopping blocks 1206 of the side walls 1205 can stop a recessed portion 1208 of the touch pad cover 1203 thus to position the touch pad 1202 and the touch pad cover 1203 in the touch pad casing 1201.

In the embodiment, the touch pad 1202 can be connected with a motherboard or a circuit board of the electronic device via a flexible flat cable (FFC), thereby achieving functions of a present touchpad. For example, the touch pad 1202 may sense movement of a finger of a user on the touch pad casing 1201 to control movement of a cursor on a screen. In the embodiment, the touch pad cover 1203 has an opening 1209 to allow the FFC to pass through. However, the invention is not limited thereto.

In the embodiment, in FIG. 4A, the touch pad cover 1203 has a first connecting portion 1204 at a back surface. The second movable element 122 has a second connecting portion 1222. The first connecting portion 1204 of the touch pad cover 1203 is movably connected with the second connecting portion 1222 of the second movable element 122 along the second direction D2, and the first connecting portion 1204 is fastened relative to the second connecting portion 1222 along the first direction D1. Thus, the touch unit 120 can move relative to the second movable element 122 along the second direction D2, and when the second movable element 122 moves along the first direction D1, the touch unit 120 can be driven to move along the first direction D1 together. In other words, the user can operate the touch unit 120 to allow the second movable element 122 to move along the first direction D1.

In the embodiment, the first connecting portion 1204 of the touch pad cover 1203 is a protrudent block, and the second connecting portion 1222 of the second movable element 122 is a groove. The protrudent block is embedded into the groove. However, the invention is not limited thereto. In other embodiments, the first connecting portion 1204 of the touch pad cover 1203 may be a groove, and the second connecting portion 1222 of the second movable element 122 may be a protrudent block. Otherwise, the first connecting portion 1204 may not be disposed, and the whole touch pad cover 1203 may move in a corresponding structure (such as a groove or a sliding rail) of the second movable element 122 along the second direction D2.

In the embodiment, in FIG. 4B, the second movable element 122 has a third connecting portion 1223 at a back surface, and the first movable element 121 has a fourth connecting portion 1214. The third connecting portion 1223 of the second movable element 122 is movably connected with the fourth connecting portion 1214 of the first movable element 121 along the first direction D1, and the third connecting portion 1223 is fastened relative to the fourth connecting portion 1214 along the second direction D2. Thus, the user can operate the touch unit 120 to allow the second movable element 122 to move relative to the first movable element 121 along the first direction D1. Further, when the first movable element 121 rotates, the touch unit 120 and the second movable element 122 can be driven to rotate together. In other words, the user can operate the touch unit 120 to allow the first movable element 121 to rotate. Thereby, the touch unit 120, the second movable element 122, and the first movable element 121 can move relative to each other and can also rotate as a whole.

In the embodiment, the third connecting portion 1223 of the second movable element 122 is a protrudent block, and the fourth connecting portion 1214 of the first movable element 121 is a groove. The protrudent block is embedded into the groove. However, the invention is not limited thereto. In other embodiments, the third connecting portion 1223 of the second movable element 122 may be a groove, and the fourth connecting portion 1214 of the first movable element 121 may be a protrudent block. Otherwise, the third connecting portion 1223 may not be disposed, and the whole second movable element 122 may move in a corresponding structure (such as a groove or a sliding rail of) of the first movable element 121 along the first direction D1.

In the embodiment, in FIG. 4A, two movement sensing elements 126 are disposed at the outer side of the second connecting portion 1222 of the second movable element 122 along the second direction D2. In FIG. 4B, the other two movement sensing elements 126 are disposed at the inner side of the fourth connecting portion 1214 of the first movable element 121 along the first direction D1.

In the embodiment, in FIG. 4B, the first movable element 121 further has a main body portion 1210 and two rotation triggering portions 1218. The rotation triggering portions 1218 are protrudent from two opposite ends of the main body portion 1210. However, the invention does not limit the number and places of the rotation triggering portions 1218. In addition, in FIG. 2, the two rotation sensing elements 128 are located at an upper side of a center line of the first movable element 121 along the second direction D2, respectively.

In addition, the invention does not limit the places of the movement sensing elements 126 and the rotation sensing elements 128. In other embodiments, the movement sensing elements 126 may not be disposed along the first direction D1 or the second direction D2 and may slant a certain angle, as long as they are located at a moving path of the touch unit 120 and the second movable element 122. Correspondingly, the rotation sensing elements 128 may be disposed along a diagonal line, as long as they are located at a rotating path of the first movable element 121.

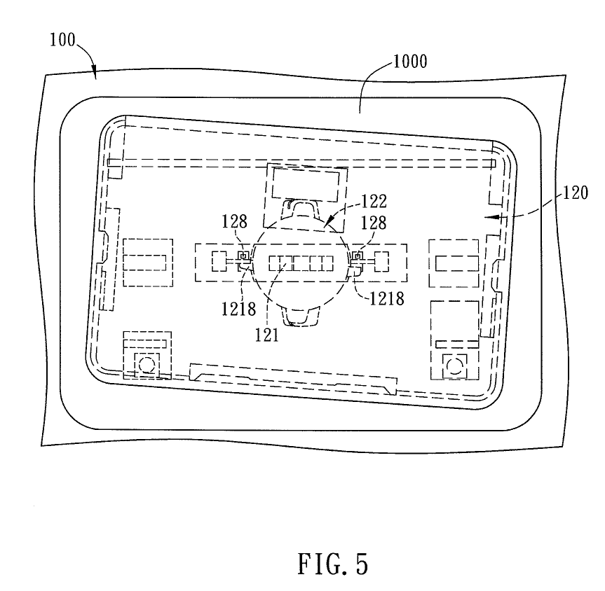

FIG. 5 is a schematic diagram showing rotation of the movable touch module 12 according to one preferred embodiment of the invention. The operation of the movable touch module 12 is described in detail hereinbelow. Please refer to FIG. 2, FIG. 4A, FIG. 4B, and FIG. FIG. 5.

In the embodiment, in FIG. 2, the touch unit 120, the first movable element 121, and the second movable element 122 are in an initial position. At that moment, the touch unit 120 and the second movable element 122 do not contact the movement sensing elements 126, and the first movable element 121 also does not contact the rotation sensing elements 128.

In the embodiment, when the user operates the touch unit 120 to move along the second direction D2, the first connecting portion 1204 (the protrudent block) of the touch unit 120 can move in the second connecting portion 1222 (the groove) of the second movable element 122 along the second direction D2, further to trigger the corresponding movement sensing element 126.

In detail, in FIG. 2 and FIG. 4A, when the user operates the touch unit 120 to move rightward along the second direction D, the first connecting portion 1204 of the touch unit 120 can trigger the movement sensing element 126 at the right side thereof, further to control the electronic device to perform a corresponding operation (such as moving a picture rightward or turning a web page backward). In addition, in the embodiment, the movement sensing element 126 is an elastic switch. Therefore, after the user releases the touch unit 120, the movement sensing element 126 can be restored by itself and can also push the touch unit 120 back to the initial position. However, the invention is not limited thereto. In a practical application, elastic elements for restoring the touch unit 120 may be set according to needs.

For example, in a practical application, when a screen of a notebook computer is not large enough, the user may move the touch unit 120 rightward to control the current web page to move rightward correspondingly. When the user releases the touch unit 120, the web page may stop moving, and the corresponding portion of the web page may be shown on the screen. Thus, the user can conveniently browse the web page just by moving the touch unit 120 along different directions.

In the embodiment, when the user operates the touch unit 120 to move along the first direction D1, since the touch unit 120 and the second movable element 122 are fastened in the first direction D1, the touch unit 120 can drive the second movable element 122 to move along the first direction D1. At that moment, the third connecting portion 1223 (the protrudent block) of the second movable element 122 can move in the fourth connecting portion 1214 (the groove) of the first movable element 121 along the first direction D1, further to trigger the corresponding movement sensing element 126.

In detail, in FIG. 2 and FIG. 4B, when the user operates the touch unit 120 to move upward along the first direction D1, the third connecting portion 1223 of the second movable element 122 can trigger the movement sensing element 126 at the upper side thereof, further to control the electronic device to perform a corresponding operation (such as moving a picture upward or turning up volume). In addition, in the embodiment, the movement sensing element 126 is an elastic switch. Therefore, after the user releases the touch unit 120, the movement sensing element 126 can be restored by itself and can also push the second movable element 122 and the touch unit 120 back to the initial position together. However, the invention is not limited thereto. In a practical application, elastic elements for restoring the second movable element 122 may be set according to needs.

In the embodiment, when the user operates the touch unit 120 to rotate, since the touch unit 120, the second movable element 122, and the first movable element 121 can rotate as a whole, the touch unit 120 can drive the first movable element 121 to rotate on the plate where the circuit board 102 is disposed.

In detail, in the embodiment, in FIG. 5, when the user operates the touch unit 120 to rotate clockwise, the touch unit 120 can drive the first movable element 121 to rotate clockwise on the plane where the circuit board 102 is disposed. At that moment, the rotation triggering portion 1218 at the left side of the first movable element 121 can contact and trigger the rotation sensing element 128 at one side, further to control the electronic device to perform a corresponding operation (such as rotating a picture clockwise or starting a certain program). In the embodiment, the rotation sensing element 128 is an elastic switch. After the user releases the touch unit 120, the rotation sensing element 128 can be restored by itself and can also push the first movable element 121 back to the initial position. However, the invention is not limited thereto. In a practical application, elastic elements such as elastic sheets for restoring the first movable element 121 may be disposed around the rotation sensing elements 128.

In addition, in the embodiment, the movable touch module 12 also has a left and right button function. In FIG. 2, the user can press the touch unit 120 to trigger the covered pressing switches 129, and the touch unit 120 can be restored to the initial position via elasticity of the elastic elements 104.

To sum up, in the embodiment, the first movable element of the movable touch module is rotatable relative to the main body on a plane; the second movable element is capable of moving relative to the first movable element along the first direction; the touch unit is capable of moving relative to the second movable element along the second direction. Thereby, the user can operate the touch unit to move along the second direction or to drive the second movable element to move along the first direction to trigger different movement sensing elements. In addition, the user can further operate the touch unit to drive the first movable element to rotate on the plane to trigger different rotation sensing elements, thereby achieving different functions. In addition, the movable touch module in the embodiment also has a left and right button function. Thus, the movable touch module and the electronic device using the same in the embodiment provide a novel design and a convenient and efficient operating mode.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A movable touch module disposed at a main body, the movable touch module comprising:
a first movable element disposed at the main body and being rotatable relative to the main body on a plane;
a second movable element disposed at the first movable element and capable of moving relative to the first movable element along a first direction;
a touch unit disposed at the second movable element and capable of moving relative to the second movable element along a second direction;
at least four movement sensing elements fastened to the main body; and
at least two rotation sensing elements fastened to the main body, wherein when the first movable element rotates on the plane, the first movable element triggers one of the rotation sensing elements, when the second movable element moves along the first direction, the second movable element triggers one of the movement sensing elements, and when the touch unit moves along the second direction, the touch unit triggers one of the movement sensing elements.

2. The movable touch module according to claim 1, wherein the first direction is vertical to the second direction.

3. The movable touch module according to claim 1, wherein the main body comprises a circuit board and a casing, the casing has a containing area, the first movable element, the second movable element, and the touch unit are stacked in the containing area, the circuit board is disposed in the casing, and the movement sensing elements and the rotation sensing elements are fastened to the circuit board.

4. The movable touch module according to claim 3, wherein the main body further comprises a plurality of elastic elements disposed at the casing.

5. The movable touch module according to claim 1, wherein the movable touch module further comprises two pressing switches fastened to the main body, and the touch unit covers the pressing switches.

6. The movable touch module according to claim 1, wherein the touch unit comprises a touch pad casing, a touch pad, and a touch pad cover, the touch pad and the touch pad cover are stacked in the touch pad casing, and the touch pad cover is disposed at the second movable element.

7. The movable touch module according to claim 1, wherein the touch unit has a first connecting portion, the second movable element has a second connecting portion, and the first connecting portion is movably connected with the second connecting portion along the second direction.

8. The movable touch module according to claim 1, wherein the second movable element has a third connecting portion, the first movable element has a fourth connecting portion, and the third connecting portion is movably connected with the fourth connecting portion along the first direction.

9. The movable touch module according to claim 1, wherein the first movable element has a main body portion and at least two rotation triggering portions, and the rotation triggering portions are protrudent from two ends of the main body portion.

10. An electronic device comprising:
a main body; and
a movable touch module disposed at the main body, the movable touch module including:
a first movable element disposed at the main body and being rotatable relative to the main body on a plane;
a second movable element disposed at the first movable element and capable of moving relative to the first movable element along a first direction;
a touch unit disposed at the second movable element and capable of moving relative to the second movable element along a second direction;
at least four movement sensing elements fastened to the main body; and
at least two rotation sensing elements fastened to the main body,
wherein when the first movable element rotates on the plane, the first movable element triggers one of the rotation sensing elements, when the second movable element moves along the first direction, the second movable element triggers one of the movement sensing elements, and when the touch unit moves along the second direction, the touch unit triggers one of the movement sensing elements.

11. The electronic device according to claim 10, wherein the first direction is vertical to the second direction.

12. The electronic device according to claim 10, wherein the main body comprises a circuit board and a casing, the casing has a containing area, the first movable element, the second movable element, and the touch unit are stacked in the containing area, the circuit board is disposed in the casing, and the movement sensing elements and the rotation sensing elements are fastened to the circuit board.

13. The electronic device according to claim 12, wherein the main body further comprises a plurality of elastic elements disposed at the casing.

14. The electronic device according to claim 10, wherein the movable touch module further comprises two pressing switches fastened to the main body, and the touch unit covers the pressing switches.

15. The electronic device according to claim 10, wherein the touch unit comprises a touch pad casing, a touch pad, and a touch pad cover, the touch pad and the touch pad cover are stacked in the touch pad casing, and the touch pad cover are disposed at the second movable element.

16. The electronic device according to claim 10, wherein the touch unit has a first connecting portion, the second movable element has a second connecting portion, and the first connecting portion is movably connected with the second connecting portion along the second direction.

17. The electronic device according to claim 10, wherein the second movable element has a third connecting portion, the first movable element has a fourth connecting portion, and the third connecting portion is movably connected with the fourth connecting portion along the first direction.

18. The electronic device according to claim 10, wherein the first movable element has a main body portion and at least two rotation triggering portions, and the rotation triggering portions are protrudent from two ends of the main body portion.

19. The electronic device according to claim 10, wherein the electronic device is a notebook computer.
